(19) United States
(12) Patent Application Publication
(10) Pub. No.: US 2005/0116792 A1
(43) Pub. Date: Jun. 2, 2005

(54) Microwave tunable device having coplanar waveguide structure

(76) Inventors: Seung Eon Moon, Daejeon-Shi (KR); Han Cheol Ryu, Seoul (KR); Min Hwan Kwak, Jinju-Shi (KR); Young Tae Kim, Seoul (KR); Sang Seok Lee, Daejeon-Shi (KR); Su Jae Lee, Daejeon-Shi (KR)

Correspondence Address: JACOBSON HOLMAN PLLC, 400 SEVENTH STREET N.W., SUITE 600, WASHINGTON, DC, 20004, US

(21) Appl. No.: 10/817,822

(22) Filed: Apr. 6, 2004

(30) Foreign Application Priority Data
Nov. 29, 2003 (KR) 2003-85998

(51) Int. Cl. H01P 1/18; H01P 3/08

(52) U.S. Cl. 333/161; 333/238

(57) ABSTRACT

Provided is a microwave tunable device having a coplanar waveguide structure, comprising a substrate, a ferroelectric/paraelectric thin film, a first transmission line, and second transmission lines, wherein a transmission line portion is formed with a constant width and an input/output portion is formed with a width larger than that of the transmission line portion in the first transmission line, and a transmission line portion is formed with a constant width and an input/output portion is formed with a narrower width than that of the transmission line portion in the second transmission line, whereby it is possible to minimize impedance difference with a connection line, a reflection loss, and an insertion loss, by controlling the width of the first transmission line and gap between the first and the second transmission lines, in the input/output portion.

### BACKGROUND

1. Field of the Invention

The present invention relates to a microwave device and, more particularly, to a microwave tunable device with a coplanar waveguide configuration including a ferroelectric/paraelectric thin film.

2. Discussion of Related Art

A ferroelectric/paraelectric oxide thin film out of dielectric oxide films has been utilized in various fields due to many characteristics thereof.

A microwave tunable device employing the ferroelectrics/paraelectrics utilizes a change of dielectric constant depending on a variation of a microstructure in the ferroelectrics/paraelectrics, when an electric field is applied thereto. For example, there is a phase shifter that is an indispensable component of an active array antenna system, a frequency tunable filter or a voltage control capacitor, a voltage control resonator, an oscillator, and a voltage control distributor.

In the case of the phase shifter employing the ferroelectrics/paraelectrics, it is possible to reduce a size and a weight of a device since the ferroelectrics/paraelectrics has a large dielectric constant, and to reduce electrical power consumption due to a low leakage current of the ferroelectrics/paraelectrics. In addition, there have been merits that it is stable to a variation of a transmission microwave power due to a characteristic thereof, fabrication processes are simple, and thus, production cost becomes lower due to a simple structure thereof, as compared with devices employing a conventional ferromagnetics or a semiconductor.

The microwave tunable device has been implanted by using a single crystal or a ceramics made by compacting powder, before a technology for growing an oxide thin film composed of multi components has been developed. However, there have been demerits that the single crystal growth is difficult and a reflection loss to a transmission wave is large, since designing for impedance matching is difficult due to relatively large dielectric constant. Recently, the microwave tunable device has been made by using the ferroelectrics/paraelectrics with a type of a thin film. At this time, the ferroelectric/paraelectric thin film should have a variable dielectric constant depending on an electric field, and a small dielectric loss. As a material capable of meeting these requirements, (Ba₁₋ₓ,Srₓ)TiO₃ (BST) has been widely used.

Meanwhile, in the microwave tunable device with the coplanar waveguide structure based on the ferroelectric/paraelectric thin film, losses caused by electrode, radiation, ferroelectrics/paraelectrics itself, and etc. may be generated, except the loss due to the design itself. Here, the loss due to the electrode could be reduced almost by making the thickness of the electrode several times larger than that of a surface passing the microwave, the loss due to radiation can be eliminated by packaging the device properly, and the loss due to the ferroelectrics/paraelectrics itself can be resolved by optimizing the thin film quality. However, the structural reflection loss and the additional insertion loss in view of the loss caused by the design itself are inevitable due to a large difference between impedance of the phase shifter and that of the connection line (for example, 50 Ω, in the case of a coaxial cable), since the ferroelectric/paraelectric thin film in the phase shifter with the coplanar waveguide configuration has a large dielectric constant. Such losses have been pointed out as a disadvantage as compared with other microwave tunable devices using ferroelectrics or semiconductor materials.

### SUMMARY OF THE INVENTION

The present invention is contrived to solve the problems and directed to a microwave tunable device with a coplanar waveguide structure including a ferroelectric/paraelectric thin film. According to the present invention, it is possible to minimize impedance difference between the phase shifter and the connection line, by controlling a line width of a transmission line and a gap between the transmission line and a ground line in an input/output portion for impedance matching.

One aspect of the present invention is to provide a microwave tunable device having a coplanar waveguide structure, comprising: a substrate; a ferroelectric/paraelectric thin film formed on the substrate with a predetermined thickness; a first transmission line formed on the ferroelectric/paraelectric thin film, and composed of a transmission line portion and an input/output portion; and second transmission lines formed on the ferroelectric/paraelectric thin film at both sides of the first transmission line, respectively, and composed of a transmission line portion and an input/output portion, wherein the transmission line portion in the first transmission line is formed with a constant width, and a width of the input/output portion is larger than that of the transmission line portion, the transmission line portion in the second transmission line is formed with a constant width, and a width of the input/output portion is narrower than that of the transmission line portion, and the width of the first transmission line and a gap between the first and the second transmission lines are determined by equations 1 to 3 as follows.

$$\begin{matrix}{Z}_{0} = \frac{30 π}{\sqrt{{ɛ}_{eff}}} \frac{{K ( k )}^{′}}{K ( k )} & [ equation 1 ] \\ k = \frac{w}{w + 2 g} & [ equation 2 ] \\ {k}^{′} = \sqrt{1 - {k}^{2}} & [ equation 3 ]\end{matrix}$$

where, Z₀ is impedance, K function is complete elliptic integral, k and k′ are integral components, w is a line width and g is a gap.

Here, the substrate is a magnesium oxide (MgO), and the ferroelectric/paraelectric thin film is (Ba₁₋ₓ,Srₓ)TiO₃ (BST).

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1A is a perspective view showing a common coplanar waveguide configuration;

FIG. 1B is a plain view of FIG. 1A;

FIG. 2 is a cross sectional view for explaining an operation of a microwave phase shifter, in which the coplanar waveguide configuration of FIG. 1A is applied;

FIGS. 3A to 3C are graphs showing a reflection loss, an insertion loss, and a microwave phase shift property, depending on frequency variation of the microwave phase shifter shown in FIG. 2;

FIG. 4A is a perspective view of a microwave tunable device having a coplanar waveguide configuration, according to the present invention;

FIG. 4B is a plain view of FIG. 4A;

FIG. 5 is a graph showing a variation of impedance depending on variations of a line width and a gap, which is calculated by a conformal mapping; and

FIGS. 6A to 6C are graphs showing a reflection loss, an insertion loss, and a microwave phase shift property depending on frequency variation of the microwave phase shifter, according to the present invention.

### DETAILED DESCRIPTION OF PREFERRED EMBODIMENTS

Hereinafter, preferred embodiments of the present invention will be described in detail with reference to the accompanying drawings. The embodiments of the present invention are intended to more completely explain the present invention to those skilled in the art.

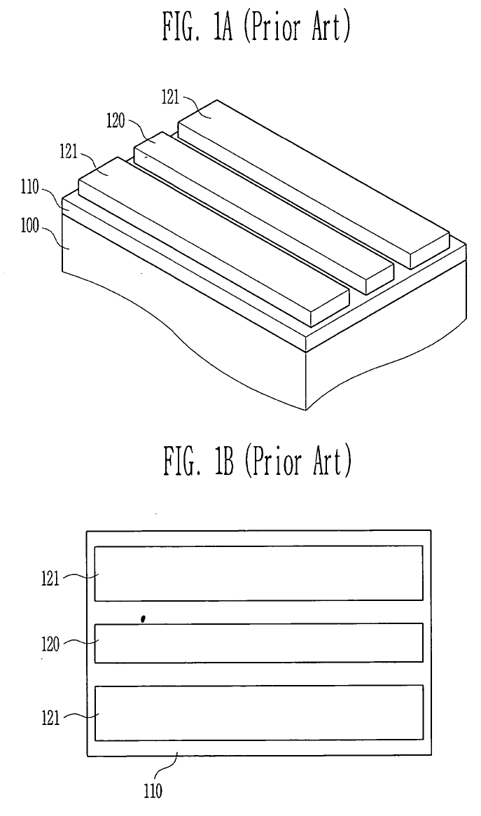

A coplanar waveguide structure based on the ferroelectric/paraelectric thin film will be described in FIGS. 1A and 11B.

A ferroelectric/paraelectric thin film 110 is formed on a magnesium oxide (MgO) substrate 100, and a first transmission line 120 and second transmission lines 121 composed of an electrode material are formed on the ferroelectric/paraelectric thin film 110, respectively. At this time, the second transmission lines 121 are formed at both sides of the first transmission line 120. Here, the second transmission line 121 and the first transmission line 120 are spaced apart with a predetermined distance.

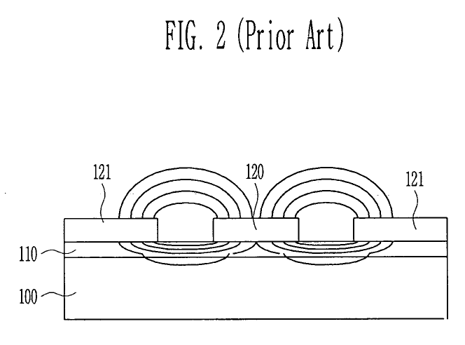

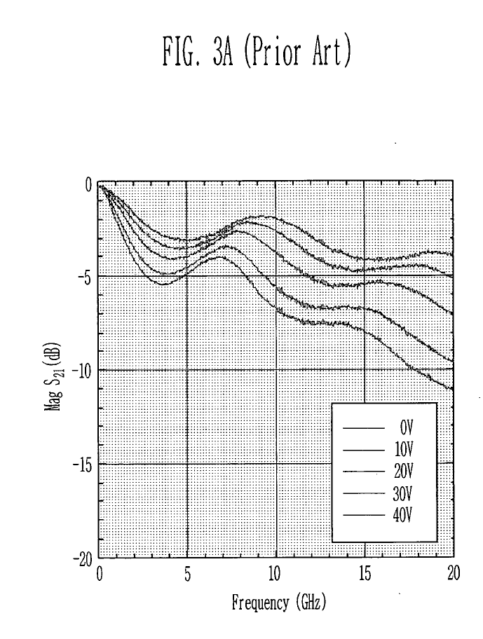

In case where the aforementioned coplanar waveguide is applied to a microwave tunable device, it operates at a direct current or an alternating current. In the case of a phase shifter, an electric field is distributed between the first transmission line 120, through which a microwave signal passes, and the second transmission line 121 used as a ground line, resulting in time delay, as shown in FIG. 2.

Impedance in the coplanar waveguide structure depends on a geometrical size of a component element, and a dielectric constant. For example, it is determined by thicknesses and dielectric constants of a substrate and a thin film, a width of the first transmission line 120 disposed in the middle, a gap between the first transmission line 120 and the second transmission line 121 disposed at both sides of the first transmission line 120, and so on. Conventionally, the coplanar waveguide has impedance of 50 Ω, which corresponds to the measuring cable impedance, or less, in case where a dielectric constant and a thickness of the ferroelectric/paraelectric thin film are 1000 and 400 nm, respectively, a dielectric constant and a thickness of the substrate are 9.6 and 0.5 mm, respectively, and each of a line width and a gap is 10 μm. Thus, the microwave tunable device having the coplanar waveguide structure, as described above, is not applicable to the phase shifter due to a large reflection loss.

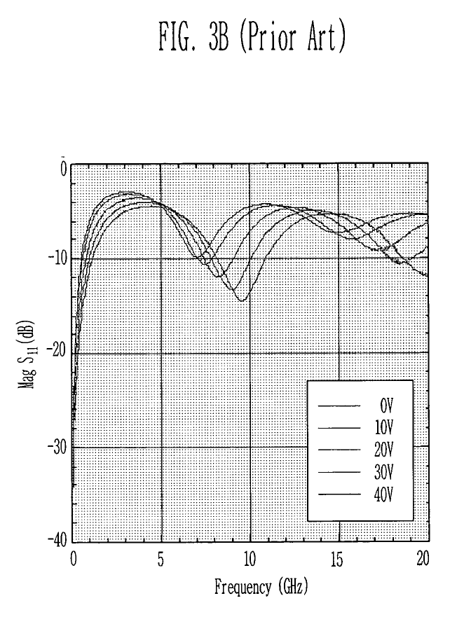

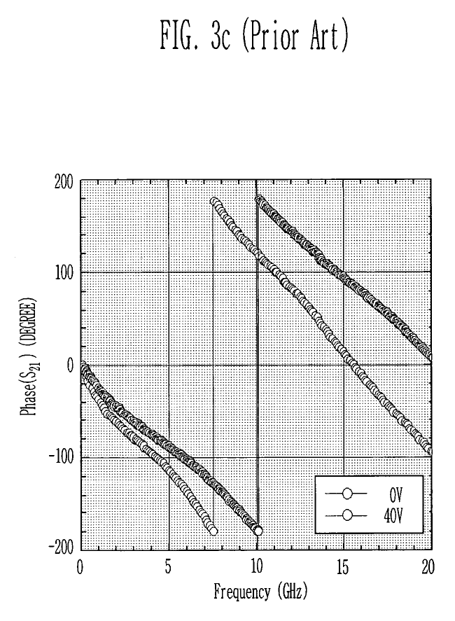

FIGS. 3A to 3C show the characteristics of the reflection loss, insertion loss, and phase shift depending on frequency variation, in the case of the phase shifter having the coplanar waveguide structure, in which impedance matching is not considered practically. The frequency region for measurement is in the range of 50 MHz to 20 GHz.

The differential phase shift at 10 GHz with a variation of 40 V corresponds to a difference of the phase shift between 0 V and 40 V, which is about 60 degree. The reflection loss and the insertion loss of about 60 degree at 10 GHz and no voltage are about −5 and −7 dB, respectively. For improving the loss properties, impedance of the coplanar waveguide should be similar to that of the measuring cable, i.e. 50 Ω.

Impedance of the coplanar waveguide depends on dielectric constants, thicknesses, gaps, line widths, and etc. of the substrate and the thin film, respectively. The impedance Z₀ calculated by conformal mapping may be defined by equation 1, as described below;

$${Z}_{0} = \frac{30 π}{\sqrt{{ɛ}_{eff}}} \frac{{K ( k )}^{′}}{K ( k )} \qquad [ equation 1 ]$$

Where, effective dielectric constant ε_{eff} is defined as a value taking dielectric constants of air, the ferroelectrics/paraelectrics thin film, and the substrate into consideration, since the microwave signal passes them. K function is complete elliptic integral, and k, k′ of integral components are defined by equations 2 and 3, as described below;

$$\begin{matrix}k = \frac{w}{w + 2 g} & [ equation 2 ] \\ {k}^{′} = \sqrt{1 - {k}^{2}} & [ equation 3 ]\end{matrix}$$

Where, w and g indicate a line width and a gap, respectively.

As known by equation 1, effective dielectric constant ε_{eff} or K(k) function should be decreased in order to increase impedance. Considering all the constants of air, substrate, and ferroelectric/paraelectric thin film, the effective dielectric constant ε_{eff} becomes influential factor in the impedance since the dielectric constant of the thin film is much larger than the others and that of air or the substrate is nearly fixed. In order to reduce the effective dielectric constant ε_{eff}, that of the ferroelectric/paraelectric thin film should be decreased, resulting in decreasing a variation rate of dielectric constant, and thus, deteriorating a differential phase shift property of the phase shifter. Therefore, it is required a method that the dielectric constant of the ferroelectric/paraelectric thin film is fixed and a line width and a gap in the coplanar waveguide structure are varied.

For decreasing the insertion loss and the reflection loss to a minimum level in the coplanar waveguide structure having the ferroelectric/paraelectric thin film, the structure thereof would be modified, and the line width and the gap are controlled to minimize impedance difference with connection line in the present invention.

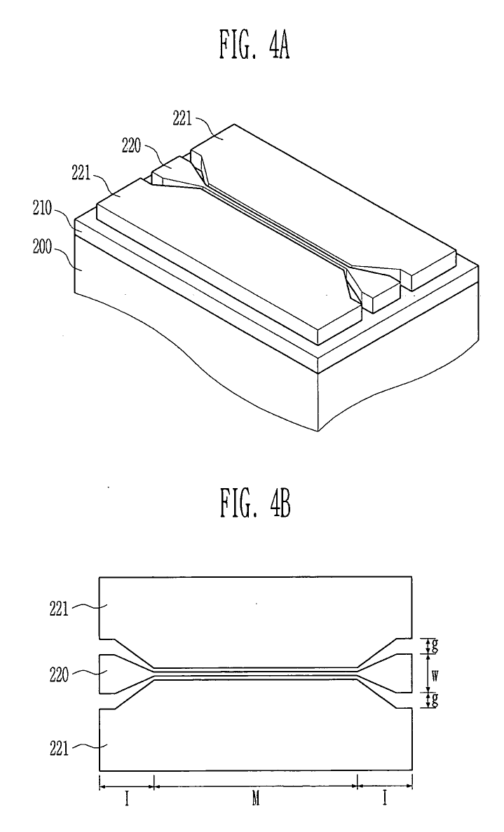

FIGS. 4A and 4B are a perspective view and a plain view for explaining a microwave tunable device having a coplanar waveguide configuration, according to the present invention.

A ferroelectric/paraelectric thin film 210 is grown on a magnesium oxide (MgO) substrate 200. At this time, the ferroelectric/paraelectric thin film 210 such as (Ba₁₋ₓ, Srₓ)TiO₃ (hereinafter, referred to as BST) is grown in the state where the temperature of the substrate 200 is increased to a predetermined level or more, and the thickness thereof may be adjusted from several nm to several μm depending on the purpose of practical use. As a growth method, a pulsed laser ablation may be used. The pulsed laser ablation is such a method that a laser such as KrF having high energy is focused on a target inside a chamber by using a reflection plate and a focusing plate, so that a material comes to be separated by the focused energy and deposited. The method is applicable to deposit a material composed of multi components, easily and rapidly, as compared with other deposition methods.

Next, a first transmission line 220 and a second transmission line 221 are formed by means of a photolithography and an etching processes after an electrode material is deposited on the ferroelectric/paraelectric thin film 210. At this time, a transmission line portion M used as a transmission line of a microwave is formed with a constant width, and an input/output portion I for impedance matching is formed with a larger width than that of the transmission line portion M in the first transmission line 220. In the case of the second transmission lines 221 that are formed at both sides of the first transmission line 220, respectively, and used as a ground line, a transmission line portion M is formed with a constant width and an input/output portion I for impedance matching is formed with a narrower width than that of the first transmission line 220. In addition, a width w of the first transmission line 220 and a gap g between the first transmission line 220 and the second transmission line 221 are determined by the equation 1 as described above. In the first and second transmission lines 220 and 221, the transmission line portion M and the input/output portion I is smoothly coupled having a gentle slope.

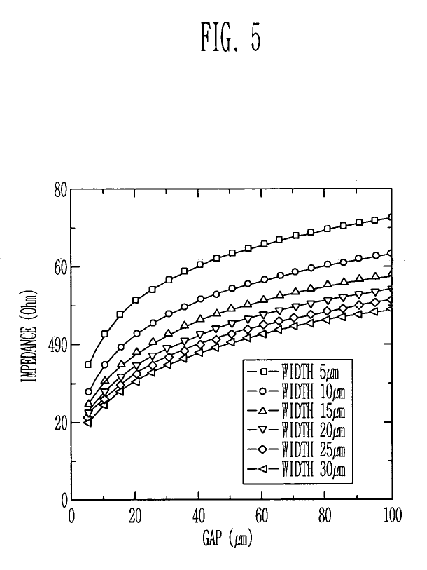

FIG. 5 is a graph showing a variation of impedance depending on variations of a line width and a gap, which is calculated by a conformal mapping, and impedance is a function of the line width and the gap with the effective dielectric constant being fixed. As known by FIG. 5, for increasing impedance with the effective dielectric constant being fixed, the line width w of the first transmission line 220 disposed in the middle should be narrowed if the gap has a constant value. On the other hand, the gap g between the first transmission line 220 and the second transmission line 221 should be increased if the line width is constant.

However, the property of the differential phase shifter needs to be controlled properly since the voltage for obtaining the desired property in the differential phase shifter becomes larger than possible value in the practical application system, if the gap in the phase shifter based on the ferroelectrics/paraelectrics becomes larger. In addition, as shown in FIG. 5, if the gap g is 10 μm or less, it is difficult to obtain impedance of 50 Ω even though the line width w could be reduced to a limitation on the photolithography process.

Thus, in the case of the phase shifter having coplanar waveguide structure based on the ferroelectrics/paraelectrics, a transmission line portion for generating the differential phase shift, which corresponds to a main role in the phase shifter, and an input/output portion are designed individually to improve the loss property.

In the transmission line portion for generating the differential phase shift, the line width, the gap, the length of the transmission line, and etc. should be determined in consideration for the value that is able to improve the loss property by impedance matching. In the input/output portion for impedance matching, a portion where the cable for measurement is coupled should be designed with 50 Ω, for example. In addition, the loss due to impedance mismatching should be reduced directly or through calculation, in order to smoothly connect with the transmission line portion.

Meanwhile, the coplanar waveguide structure of FIG. 1A that impedance matching is not considered is composed of the transmission line for generating the differential phase shift. However, in the case of the structure of FIG. 4A that impedance matching is considered, it is composed of a transmission line portion M and an input/output portion I for impedance matching.

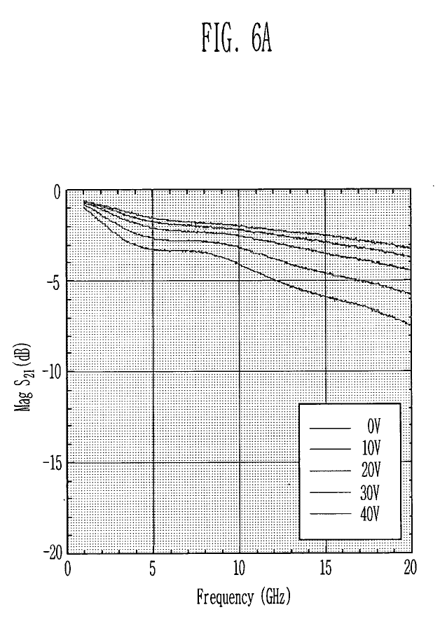

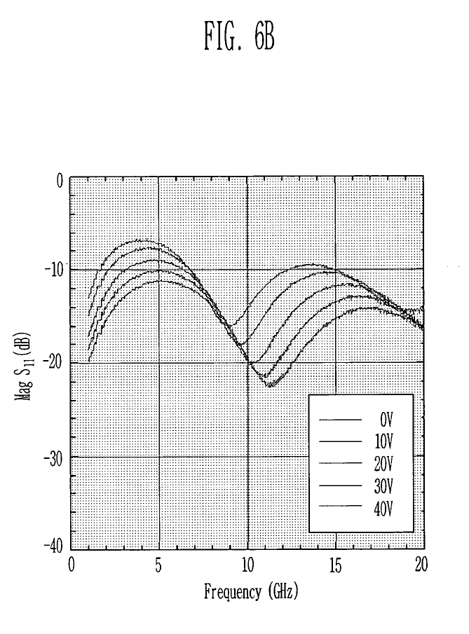

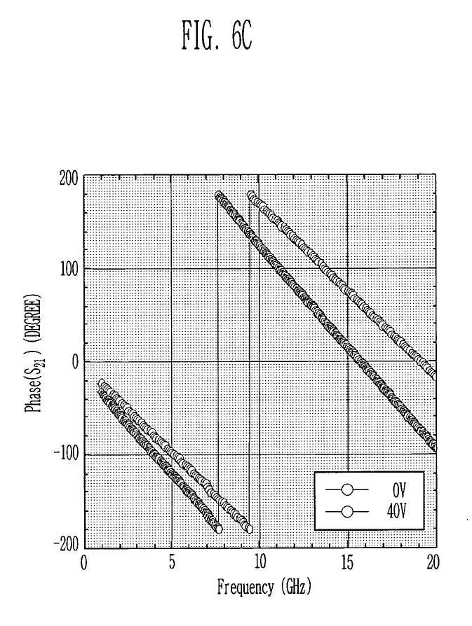

FIGS. 6A to 6C are graphs showing a reflection loss, an insertion loss, and a microwave phase shifter characteristic, depending on a frequency variation of the microwave phase shifter according to the present invention.

In the configuration of FIG. 1A that impedance matching is not considered, the first transmission line 120 and the second transmission line 121 have a length of 4 mm and a line width of 10 μm, respectively. Meanwhile, in the configuration of FIG. 4A that impedance matching is considered, the transmission line portion M in the first transmission line 220 has a length of 3 mm, a line width of 10 μm, and the gap of 10 μm between the first and the second transmission lines. Here, the ferroelectric/paraelectric thin films 110 and 210 may be composed of BST, and have the same thicknesses as those of the MgO substrate 100 and 200.

FIGS. 6A to 6C show a reflection loss, an insertion loss, and a microwave phase shift property depending on frequency, in case where the input/output portion is connected to the transmission line portion. Here, the transmission line portion has the gap of 10 μm and the line width of 10 μm, and the length of 3 mm, and the input/output portion has the gap and the line width calculated with impedance (i.e. 50 Ω), which is obtained by the conformal mapping as shown in FIG. 5.

Comparing with the properties of FIGS. 3A to 3C shown in the structure of FIG. 1A that impedance matching is not considered, it can be noted that the properties of the reflection and insertion losses are improved as a whole in the range of the measured regions. The reflection and the insertion losses at the measured frequency of 10 GHz with direct current not applied are about −14 dB and −4 dB, respectively, and the differential phase shift at a voltage variation of 40 V is 44 degrees. In other words, the differential phase shift comes to be decreased proportional to a decrease of the length of the transmission line portion, as compared with the structure that impedance matching of the input/output terminal is not considered. However, the reflection loss is remarkably improved, as compared with the structure that impedance matching is not considered, that is, it has a value of about 9 dB on the basis of the measured frequency of 10 GHz. The insertion loss would be expected to decrease since the length of the transmission line portion becomes shorter in the structure that impedance matching is considered. However, the result is more improved than expected.

As described above, the microwave tunable device with the coplanar waveguide structure according to the present invention has an excellent response property in view of the reflection loss and the insertion loss. Therefore, according to the present invention, it is possible to reduce the loss of the radio wave in the active antenna system or satellite communication systems, thereby reducing the deformation or loss of the data. Further, the present invention has an advantage of the output efficiency in the total system since amplification could be decreased when the radio wave is emitted into the antenna.

Although the present invention have been described in detail with reference to preferred embodiments thereof, it is not limited to the above embodiments, and several modifications thereof may be made by those skilled in the art without departing from the technical spirit of the present invention.

For example, in the preferred embodiment of the present invention, MgO substrate was used as the substrate of the microwave tunable device. However, the present invention could be employed in the case of implanting the microwave device on another substrate. In addition, the present invention is applicable to a voltage tunable capacitor, a voltage tunable resonator, a voltage tunable filter, a phase shifter, a distributor, an oscillator, and so on.

The present application contains subject matter related to korean patent application no. 2003-85998, filed in the Korean Patent Office on Nov. 29, 2003, the entire contents of which being incorporated herein by reference.

1. A microwave tunable device having a coplanar waveguide structure, comprising:
a substrate;
a ferroelectric/paraelectric thin film formed on the substrate with a predetermined thickness;
a first transmission line formed on the ferroelectric/paraelectric thin film, and composed of a transmission line portion and an input/output portion; and
second transmission lines formed on the ferroelectric/paraelectric thin film at both sides of the first transmission line, respectively, and composed of a transmission line portion and an input/output portion,
wherein the transmission line portion in the first transmission line is formed with a constant width, and a width of the input/output portion is larger than that of the transmission line portion,
the transmission line portion in the second transmission line is formed with a constant width, and a width of the input/output portion is narrower than that of the transmission line portion, and
the width of the first transmission line and a gap between the first and the second transmission lines are determined by equations 4 to 6 as follows.
$$\begin{matrix}{Z}_{0} = \frac{30 π}{\sqrt{{ɛ}_{eff}}} \frac{{K ( k )}^{′}}{K ( k )} & [ equation 4 ] \\ k = \frac{w}{w + 2 g} & [ equation 5 ] \\ {k}^{′} = \sqrt{1 - {k}^{2}} & [ equation 6 ]\end{matrix}$$
where, Z₀ is impedance, K function is complete elliptic integral, k and k′ are integral components, w is a line width and g is a gap

2. The microwave tunable device having a coplanar waveguide structure claimed as claim 1, wherein the substrate is a magnesium oxide (MgO).

3. The microwave tunable device having a coplanar waveguide structure claimed as claim 1, the ferroelectric/paraelectric thin film is (Ba₁₋ₓ, Srₓ)TiO₃ (BST).
